(19) United States
(12) Patent Application Publication
(10) Pub. No.: US 2010/0007489 A1
(43) Pub. Date: Jan. 14, 2010

(54) ADAPTIVE LEARNING FOR ENTERPRISE THREAT MANAGMENT

(76) Inventors: Janardan Misra, Bangalore (IN); Indranil Saha, Kolkata (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/171,231

(22) Filed: Jul. 10, 2008

(51) Int. Cl. G08B 21/00

(52) U.S. Cl. 340/540

(57) ABSTRACT

A reactive approach to enterprise threat management provides a solution to the problem of prioritizing security violations. In an embodiment, a linear adaptive learning approach is aimed towards a system which could effectively assist security administrators to prioritize reported violations. The approach is adaptive in the sense that the system can change its logic over a course of time controlled only by some specified structural constraints. A learning aspect specifies that any mismatch between a system's response and the response of a security expert is propagated back to the system for adapting the difference such that the responses of the system should increasingly match against the security expert's responses over time. The presented algorithm learns and predicts simultaneously, continually improving its performance as it makes each new prediction and finds out how accurate it is.

### TECHNICAL FIELD

Various embodiments relate to security systems, and in an embodiment, but not by way of limitation, to adaptive learning for enterprise threat management.

### BACKGROUND

Most solutions to enterprise threat management are preventive approaches. These approaches only prescribe what should be done to prevent security policy violations or how to monitor such violations. However, these other approaches do not provide how to deal with these violations once they have already occurred. Similarly, there are solutions with very limited scopes to generate automated responses for specific type of threats (e.g., fire alarms, account locking owing to incorrect password entry while accessing the account, etc). These solutions are primarily governed by a fixed set of rules that determine the detection of the specific threat and/or violation and generate a predefined response accordingly. The prior art lacks a system that generates effective responses adaptively to handle enterprise level threats on a wide scale of security threats and/or violations.

### BRIEF DESCRIPTION OF THE DRAWINGS

FIG. 1 illustrates an example of a comparison between a linear system response and an ideal administrator's response.

FIG. 2 illustrates an example schematic representation of learning and adaptation in a model.

FIG. 3 illustrates an example schematic representation of a system design.

FIG. 4A illustrates an example geometric interpretation of an ortho-normal least squares algorithm.

FIG. 4B illustrates an example geometric interpretation of a partial least squares algorithm.

FIG. 5 illustrates an example recursive process for a block-wise recursive partial least square algorithm.

FIG. 6A illustrates an example block diagram for a cross-validation modeling using a block-wise recursive partial least squares algorithm.

FIG. 6B illustrates an example block diagram for a partial least squares modeling using a block-wise recursive partial least squares algorithm.

FIG. 7 illustrates an example computer architecture upon which one or more embodiments of the present disclosure can operate.

FIG. 8 is a flowchart of an example process to prioritize threats or violations in a security system.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein. As used herein, the term processor means one or more processors, and one or more particular processors can be embodied on one or more processors.

One or more figures show block diagrams of systems and apparatus of embodiments of the invention. One or more figures show flow diagrams illustrating systems and apparatus for such embodiments. The operations of the one or more flow diagrams will be described with references to the systems/apparatuses shown in the one or more block diagrams. However, it should be understood that the operations of the one or more flow diagrams could be performed by embodiments of systems and apparatus other than those discussed with reference to the one or more block diagrams, and embodiments discussed with reference to the systems/apparatus could perform operations different than those discussed with reference to the one or more flow diagrams.

Enterprise threat management demands appropriate decision making for generating optimal responses to reported threats and/or violations. Prioritization of reported threats and/or violations in order to optimize the response to these threats and/or violations with limited resources is an important problem faced by security administrators. This problem becomes even more severe when considering the collaborative monitoring and reporting of the threats by users, since user reported threats and corresponding details by nature are required to be closely analyzed to assess the truth and falsity of the reported threat, and also to determine actual priority for response generation. Moreover, in scenarios where a multitude of reported threats are present at any time point, such prioritization may become a mandatory requirement to suitably meet the requirement of determining the most critical of the reported threats and/or violations. Thus optimization (minimization) of the response cost and the generation of an adequate response to the most critical of the actual threats and/or violations are two prime objectives for any security administrator.

The problem of prioritizing reported security threats and/or violations should be considered by a security administrator at any time point. This prioritization could be displayed in a dashboard format indicating the degree of criticality of the reported threats and/or violations in order to generate the optimal response.

The problem of accurate prioritization of threats and/or violations is in general a difficult problem to solve since it requires numerous factors to be adequately considered and accurately assessed. Examples of these factors may include security policies, profiles of the reporting user(s), reporting time, security infrastructure, and severity level. Most of these and other relevant factors vary with respect to organizations, time, security priorities of an organization, user bases, and other existing reported threats. Often the way these factors impact the actual relative criticality of a reported threat and/or violation varies dynamically, and the impact therefore cannot be accurately predicted a priori using any static modeling approach.

Indeed, an assessment of the threats and/or violations based upon any requirements needed to respond to these threats and/or violations on a system, and the corresponding optimal scheduling of the available resources, is a computationally difficult problem. This is particularly the case in scenarios where new threats and/or violations are continually being reported—known as online scheduling (with or without preemption).

Because of these difficulties, system security administrators often use their personal experience and informal reasoning to decide the appropriate prioritization and response to such security threats and/or violations. Such prioritization by an expert may be the only option available at times, however it may not be the best possible option. Also, undue dependence in a system on such subjective decision making might result in inconsistent decisions. There may be also be a loss of such expertise once an expert leaves the organization.

Consequently, one or more embodiments involve a prediction technique that learns over time. Essentially, the technique involves a linear adaptive learning-based approach, which is aimed towards a system that could effectively assist system security administrators in prioritizing reported threats and/or violations. The approach is adaptive in the sense that the system can change its logic (definition of the function) over a course of time controlled only by some specified structural constraints as is disclosed herein. The learning aspect specifies that any mismatch between a system's response and a response of a security expert is propagated back to the system for adapting the difference such that the responses of the system should increasingly match against the security experts' responses over time. The algorithm learns and predicts simultaneously, continually improving its performance as it makes each new prediction and finds out how accurate it is.

In an embodiment, χ denotes the set of the ‘types’ of security violations or, in general, policy violations that could occur in a system or environment. The term χₜ is the set of all reported but unfinished (i.e., no decision taken) instances of threats and/or violations at some point in time t. It is assumed that security threats and/or violations are being continuously reported, and in general the reporting of a threat and/or violation is independent of the other reported threats and/or violations. These instances of the threats and/or violations in χₜ are suitably prioritized for optimal response. The term γ is the set of all priorities or dash-board values to be assigned to the reported threats and/or violations such that higher priority is represented by higher numerical value.

The term Π is a set of all environmental factors that impact the criticality level and/or relative priority of the reported threats and/or violations. These factors are considered to be measurable, which means that their values for any reported threat and/or violation could be measured on some numerical scale. Examples of such factors include:

### Associated Security Policies:

Type of the policy and associated factors—for example, business policy, intellectual property (IP) policy, access control policy, human resources (HR) policy (e.g., employee separation policy), and information technology security policies (e.g., password policy).
Measured business importance of the policy for the organization.

### Profile of the Reporting User(s):

Number of users reporting the same threat and/or violation.
Mutual relationship between the reporting user(s).
Employment status of the reporting user(s)—for example, full time employees, employees that have given notice that they are soon leaving the company, employees under probation, part time employees, trainees, contract employees, and a temporary visit by an employee or other person.
Relationship of the reporting user(s) with the policy and violation based upon job role and responsibility—for example, expected close relation/generic relationship/remote relation.
Time of reporting a threat and/or violation and a delay in reporting a threat and/or violation. For example, in certain organizations, a delay in reporting a violation can cause that violation to be given a higher priority.
Past violation history and response rating for the threat and/or violation. For example, a particular violation may have occurred in the past, and because of that prior occurrence, the organization knows that a particular priority should be assigned to the violation.

### Type of the Violation:

Data manipulation-related violations:
   Unsolicited modification of a design document.
   Source code modification and transfer.
   Unauthorized access and modification of employee Human Resources (HR) data.
   Unauthorized access and modification of employee salary data.
   Unauthorized access and modification of employee performance appraisal data.
   Unauthorized access and modification/transfer of classified information (e.g., defense sensitive information).
   Unauthorized access and modification/transfer of sensitive client data.
   Unauthorized access to official email accounts and consequent emailing of nefarious contents.
   Unauthorized access and copying of contents from others' computers.
Physical Access violations:
   Unauthorized access to secure installments (e.g., gas pipelines) and consequent act of damage.
   Deliberate facilitation to gain unauthorized access to restricted facilities, e.g., tailgating.
   Theft or facilitation of theft of valuable property, e.g., laptops.
Other violations:
   Illegal Intellectual Property (IP) leaks—for example, transfer of secret molecular codes to competitors.
   Illegal transfer of strategic documents (for example, on project biddings) to competitors.
   Unauthorized outsourcing of (personal) project work.
   Unlocked device.
   Sharing or facilitating the sharing of passwords.
   Financial decisions against company's interest motivated by personal gains, e.g., extending contracts in an unfair manner.
   Deliberate hiding of valuable information.
   Physically/psychologically aggressive behavior.
   Deviant behaviors with respect to defined business code of conduct—for example, extending unsolicited favors to friends/relatives.

### Other Associated Factors:

Intellectual Property (IP) Leaks:
   Legal status—the status of the IP may affect the prioritizing and/or response (for example, is the IP undisclosed, disclosed, filed, patented, licensed and/or published).
   IP association—confidential/external/internal
Project associations
Customer Associations
Knowledge of the violating user—for example, internal employee or external person.
   Supporting Evidence From the Automated Monitoring System, if available. External Factors Including Such Things as Socio-Political Regulations and/or Natural Exigencies.

Based upon the above, the following function is defined:

ƒ(ν, χₜ,env)├→priority

where ν ∈ χₜ, env ⊂ Π, and priority ∈ γ.

Since a closed form solution (i.e., a program which completely captures the logic to solve the problem) for such a function is unlikely to be definable, an adaptive learning-based approach is employed, which can approximately capture the desired effect of such a function. Adaptive learning specifies that the underlying logic controlling the system responses would change (i.e., definition of the function ƒ) over a course of time controlled by specific structural constraints, and the error propagation resulting from any mismatch between a system's current response and a response of security expert is addressed such that the responses of the system should increasingly match the responses of a security expert over time. The structural constraints determine the structure of equation (0) below for defining the priority function. As can be seen in the given equation (0), it has only two key terms—one linear term which accounts for the environmental factors which are directly relevant to a reported threat and/or violation and a second delta term, which accounts for the meta-knowledge used by an expert over and above these factors to determine relative priority of reported threats and/or violations.

### Linear Adaptive Design

The function ƒ is defined as follows:

ƒ(ν, χₜ,env)≡Σβᵢᵥ*xᵢᵥ(t)+Δ,(v) (0)

wherein xᵢᵥ ∈ env are the environmental factors affecting the priority/criticality level of the reported violation, and βᵢᵥ is the weight/coefficient for the factor xᵢᵥ with respect to the violation v ∈ χₜ. These coefficients can be initialized to 1. The symbol * represents multiplication.

In an embodiment, it is assumed at this point that all the valuations for βᵢᵥ and xᵢᵥ are normalized such that their summation yields a value representing a priority level in γ. In practice this can be achieved either by measuring xᵢᵥ as a cost to the organization, or a further arithmetic normalization on a standard priority scale. For example, for an IP leak as a violation, if disclosure status is considered an attributing factor, then IP for which a patent application has been filed could mean zero cost to the organization, whereas un-filed IP may have higher cost to the organization as per its business value. Alternatively, a statistical approach could be adopted by subtracting the xᵢᵥ from the mean and dividing further by the standard deviation.

A type of a violation is characterized by a set of factors xᵢᵥ ⊂ env associated with it. The first term, Σβᵢᵥ*xᵢᵥ, appearing in the right hand side of equation (0), only considers those factors which impact the violation v. Sometimes it may not be sufficient to only consider these factors in isolation to determine the relative priority of a violation. In such scenarios, a security expert may need to make a decision on the relative priority of the violation v, with the knowledge that
Many other types of violations can also be present at the same time
Different sets of factors characterize these violations
Some global ‘meta-level’ information is critical to consider, for example, current expertise of the security response team and underlying connectivity topology.
   These and other similar factors with global information, which affect the relative priorities of the reported threats and/or violations, but which are not captured in the set of environmental factors, can be referred to as “meta knowledge” or “meta factors”.

Such meta knowledge cannot be captured and/or derived in purely statistical terms (e.g., by correlation) using only the factors present in the linear terms (i.e, X₁ᵥ, X₂ᵥ, . . . X_{1w}, X_{2w}, . . . , priorityᵥ, priority_{w}, . . . ). These correlations, if present among the factors and the priorities, would be dealt with using the standard partial least square regression learning as discussed later. The following is an example about a need to introduce a second term in the model.

Given a scenario where violations v₁ and v₂ have been reported at time t, a supposition can be made that the key factor that is known about these violations is the distance of their occurrences from a security control room from where a security response team would be sent to attend to these violations. Then, if d₁ and d₂ are the distances of the places where v₁ and v₂ occur respectively, such that d₁<d₂, and if in this example distance is the only factor to be considered, v₁ would be assigned higher priority over v₂ by the linear system model as well as the security administrator.

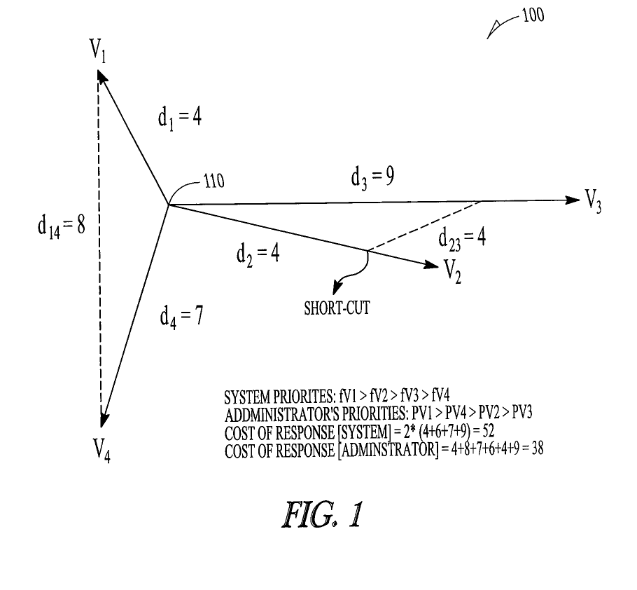

FIG. 1 illustrates another scenario 100 where four violations v₁, v₂, v₃, and v₄ have been reported. In this case, as in the scenario described in the previous paragraph, the distances of the occurrences of these violations from the main security control room 110 are important factors known to the system and they can be used to decide the relative priorities of the four violations. These distances are designated d₁, d₂, d₃, and d₄ in FIG. 1 such that d₁<d₂<d₄<d₃. As per the linear term, the system would determine the priorities in the same way as the scenario described in the previous paragraph, that is, fv₁>fv₂>fv₄>fv₃, where fvᵢ represents the priority given to violation vᵢ. However, upon closer analysis, a system administrator can decide that v₄ would be assigned higher priority over v₂, even though d₄>d₂, since the point of occurrence of v₄ and v₁ have a connection reducing the overall distance to be covered. Example costs corresponding to the priorities given by the linear system model, as well as an ideal system administrator's response, are illustrated in FIG. 1. Such considerations demand that a system should consider the overall cost of the response rather than just a single response in isolation. Since in general such factors (or meta-considerations) that need to be considered globally across more than one violation are specific to the violations and other surrounding conditions, a heuristically defined second term, Δₜ(v), in the equation (0) can be used to overcome this limitation.

The term Δₜ(v) is the average relative historical priority associated with v as compared to other violations sharing the history with v. The term Δₜ(v) captures the effect of earlier priorities assigned to the violation v with respect to some other violations in χₜ, which were also present together with v at those points in the past. It can be defined as follows:

Let

History(t)={χᵤ ⊂ χ|0<u<t},

History(t, v)={χᵤ ∈ History(t)|v ∈ χᵤ} ranged over by χ_{u,t}

And

χₜᵥ^{u}=(χ_{u,t}∩χₜ)/{v}

χₜᵥ^{u} contains the sets of reported threats and/or violations at those time points in the past when violation v was also present. Let pri(x, u) be the absolute priority assigned to a violation x ∈ χᵤ, (by a security administrator). Also let α(v, u) be the valuation of the equation (0), i.e., predicted priority, at time u for violation v.

Now define, for w ∈ χₜᵥ^{u}

$$\begin{matrix}{φ}_{u} ( v , w ) = 0 if ( pri ( v , u ) - pri ( w , u ) ) * ( α ( v , u ) - α ( w , u ) ) > 0 \\ = 1 otherwise \\ {λ}_{tv}^{u} = {\sum }_{w} [ {φ}_{u} ( v , w ) ( pri ( v , u ) - pri ( w , u ) ]\end{matrix}$$

Informally, λ^{u}ₜ represents a total relative priority of the violation v as compared to all other violations w present both in the current set of violations χₜ as well as in some previous set of violations χᵤ. Factor φᵤ(v, w) is used to estimate whether there is a directionality mismatch between the relative priorities assigned to violations v and w at time u by the linear system model and the system administrator. If a directionality mismatch is present, then in that case it is likely to be a result of a presence of some meta-factors as discussed previously, and hence need to be suitably captured. The term λ^{u}ₜᵥ defined above is one possible way to capture such effect. Now Δₜ can be concretely defined as follows:

$$\begin{matrix}{Δ}_{t > 0} ( v ) = ⌈ ( \sum {λ}_{tv}^{v} / \vert {History}_{meta} ( t , v ) \vert ) * ( ( \vert ⋃ {Θ}_{tv}^{u} \vert + 1 ) / \vert {X}_{t} \vert ) ⌉ \\ if {\sum }_{ }^{ } {λ}_{tv}^{u} > 0 \\ = 0 otherwise \\ {Δ}_{t = 0} ( v ) = 0\end{matrix}$$

Notation ┌a┐ refers to the nearest integer greater than a. In the equation,

Θₜᵥ^{u}=Xₜᵥ^{u}−{w ∈ Xₜᵥ^{u}|φᵤ(v, w)=0}

Historyₘₑₜₐ(t, v)={Θₜᵥ^{u}|Θₜᵥ^{u} is not empty}

For illustration, consider an example:

$$χ = \{ v , {v}_{1} , {v}_{2} , … , {v}_{100} \}$$

$${χ}_{0} = \{ {v}_{13} , {v}_{2} , {v}_{17} , {v}_{8} , v , {v}_{16} , {v}_{11} , {v}_{12} , {v}_{71} , {v}_{26} , {v }_{44} \}$$

$${χ}_{1} = \{ {v}_{37} , {v}_{82} , {v}_{20} , {v}_{14} , {v}_{53} , {v}_{72} , {v}_{90} , {v}_{31} , {v}_{19} \}$$

$${χ}_{2} = \{ {v}_{55} , {v}_{16} , {v}_{77} , {v}_{61} , {v}_{39} , {v}_{12} , {v}_{20} , {v}_{11} , {v}_{14} , v , {v}_{3} , {v}_{50} , {v}_{2} , {v}_{21} , {v}_{17} \}$$

$${χ}_{3} = \{ v , {v}_{13} , {v}_{11} , {v}_{57} , {v}_{77} , {v}_{15} , {v}_{3} , {v}_{4} , {v}_{8} , {v}_{71} , {v}_{12} , {v}_{50} , {v}_{67} \}$$

Let t=3, and the violation under consideration by v,

History(3)={χ₀, χ₁, χ₂} and History(3, v) ={χ₀, χ₂}

χ₃ᵥ⁰={v₁₃,v₁₁,v₈,v₇₁} and χ₃ᵥ²={v₁₁,v₇₇,v₃,v₁₂,v₅₀}

### Let

$$ϒ = \{ 1 , 2 , … , 20 \}$$

$$pri ( v , 0 ) = 5 , pri ( {v}_{13} , 0 ) = 3 , \\ pri ( {v}_{8} , 0 ) = 7 , pri ( {v}_{11} , 0 ) = 4 , pri ( {v}_{71} , 0 ) = 6$$

$$pri ( v , 2 ) = 10 , pri ( {v}_{11} , 2 ) = 8 , pri ( {v}_{77} , 2 ) = 3 , pri ( {v}_{3} , 2 ) = 11 , \\ pri ( {v}_{12} , 2 ) = 6 , pri ( {v}_{50} , 2 ) = 12 \\ and \\ α ( v , 0 ) = 4 , α ( {v}_{13} , 0 ) = 1 , α ( {v}_{8} , 0 ) = 2 , α ( {v}_{11} , 0 ) = 7 , α ( {v}_{71} , 0 ) = 9 \\ α ( v , 2 ) = 8 , α ( {v}_{11} , 2 ) = 9 , α ( {v}_{77} , 2 ) = 5 , α ( {v}_{3} , 2 ) = 6 , \\ α ( {v}_{12} , 2 ) = 11 , α ( {v}_{50} , 2 ) = 4$$

The following can then be calculated:

$$\begin{matrix}{λ}_{3 v}^{0} = 0 * [ pri ( v , 0 ) - pri ( {v}_{13} , 0 ) ] + 1 * [ pri ( v , 0 ) - pri ( {v}_{8} , 0 ) ] + \\ 1 * [ pri ( v , 0 ) - pri ( {v}_{11} , 0 ) ] + 0 * [ pri ( v , 0 ) - pri ( {v}_{71} , 0 ) ] \\ = [ 5 - 7 ] + 0 + [ 5 - 4 ] + 0 = - 1\end{matrix}$$

### Similarly,

λ₃ᵥ²=3

Finally,

Δ₃(ν)=┌[(−1+3)/2]*[((2+4)+1)/12]┐=1

Intuitively it can be seen that the value indicates that the violation v could probably be assigned priority 1 based upon the priorities assigned to it earlier with respect to the priorities assigned to other violations which were also present in past.

In another embodiment, a learning scheme includes coefficients for the linear adaptive function ƒ defined above for specific violations that can be changed recursively so that the learning scheme can capture the effect of learning the knowledge used by the security administrator.

In this embodiment, the recursive partial least square regression (RPLS) technique as defined in Recursive PLS Algorithms For Adaptive Data Modeling, S. Joe Qin, Computer Chemical Engineering, Vol. 22, No. 4/5, pp. 503-514, 1998, which is incorporated herein by reference, and which is described in detail below, is used. Multiple regression is a powerful statistical modeling and prediction tool that has found wide applications in biological, behavioral, and social sciences to describe relationships between variables. Least square estimations (LSE) are among the most frequently used analysis techniques in multiple linear regression analysis. Intuitively, least square estimates aim to estimate the model parameters (coefficients) such that a total sum of squared errors (deviation from the ideal system response of the model's output) is minimized. A feature of these LSE is that their derivations employ standard operations from matrix calculus, and therefore they bring with them the theoretical proofs of optimality.

The following notations are used:
(.)^{T}—Transpose of a vector or matrix.
∥.∥—Frobenius norm of a matrix
[symbol] —Set of real numbers

Given a pair of input and output data matrices X and Y and assuming they are linearly related by

Y=XC+V (1)

where V and C are noise and coefficient matrices, respectively. In an embodiment, the noise matrix v is considered to be 0 or null. The PLS regression builds a linear model by decomposing matrices X and Y into bilinear terms,

X=t₁p₁^{T}+E₁ (2)

Y=u₁q₁^{T}+F₁ (3)

where t₁ and u₁ are latent score vectors of the first PLS factor, and p₁ and q₁ are corresponding loading vectors. All four vectors are determined by iteration with t₁ and u₁ being eigenvectors of XX^{T}YY^{T} and YY^{T}XX^{T} respectively. Note that XX^{T}YY^{T} is the transpose of YY^{T}XX^{T} and vice versa; therefore, the two matrices have identical eigen values. The above two equations formulate a PLS outer model. The latent score vectors are then related by a linear inner model:

u₁=b₁t₁+r₁ (4)

where b₁ is a coefficient which is determined by minimizing the residual r₁. After going through the first factor calculation, the second factor is calculated by decomposing the residuals E₁ and F₁ using the same procedure as for the first factor. This procedure is repeated until all specified factors are calculated. The overall PLS algorithm is summarized in Table 1 to introduce relations for further derivation. Note that a minor modification is made in this algorithm such that the latent variables tₕ are normalized instead of wₕ and pₕ. This modification makes it easier to derive the recursive PLS regression algorithm. As a result, the latent vectors tₕ(h=1, 2, . . . ), are orthonormal.

The total number of factors required in the model is usually determined by cross-validation, although an F-test can be used. A standard way of doing cross-validation is to divide the data into s subsets or folds, leave out a subset of data at a time, and build a model with the remaining subsets. The model is then tested on the subset which is not used in modeling. This procedure is repeated until every subset has been left out once. Summing up all the test errors for each factor, a predicted error sum of square (PRESS) results. The optimal number of factors is chosen as the location of the minimum PRESS error. The cross-validation method is computation intensive due to repeated modeling on a portion of the data.

TABLE 1
A traditional batch-wise PLS algorithm

| 1. Scale X and Y to zero-mean and unit-variance. | |
|---|---|
| Initialize E₀:=X, F₀:=Y, and h:=0. | |
| 2. Let h:=h + 1 and take uₕ as some column of Fₕ₋₁. | |
| 3. Iterate the PLS outer model until it converges: | |
| wₕ = Eₕ₋₁^{T}uₕ/uₕ^{T}uₕ | (5) |
| tₕ = Eₕ₋₁wₕ/\|\|Eₕ₋₁wₕ\|\| | (6) |
| qₕ = Fₕ₋₁^{T}tₕ/\|\|Fₕ₋₁^{T}tₕ\|\| | (7) |
| uₕ = Fₕ₋₁qₕ | (8) |
| 4. Calculate the X-loadings: | |
| pₕ = Eₕ₋₁^{T}tₕ/tₕ^{T}tₕ = Eₕ₋₁^{T}tₕ | (9) |
| 5. Find the inner model: | |
| bₕ = uₕ^{T}tₕ/tₕ^{T}tₕ = uₕ^{T}tₕ | (10) |
| 6. Calculate the residuals: | |
| Eₕ = Eₕ₋₁tₕ − tₕpₕ^{T} | (11) |
| Fₕ = Fₕ₋₁ − bₕtₕqₕ^{T} | (12) |

7. Return to step 2 until all principal factors are calculated.

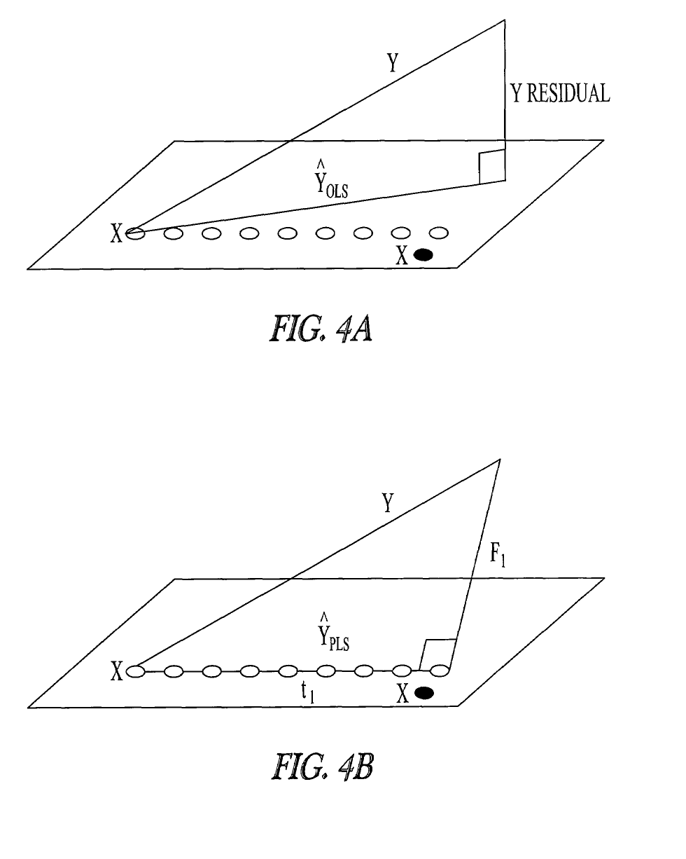

The robustness of a regression algorithm refers to the insensitivity of the model estimate to ill-conditioning and noise. The robustness of PLS vs. OLS can be illustrated geometrically as in FIGS. 4A and 4B, which depicts an extreme case of collinear and noisy data with two inputs and one output. All the input data are exactly collinear except for one data point, x, which is corrupted with noise. These data span a two-dimensional subspace X. The OLS approach in FIG. 4A projects the output Y orthogonally to X. However, since the data point x is corrupted with random noise which causes its location to be random, the orientation of the plane X is heavily affected by the location of x. As a result, the OLS projection Ŷ_{OLS} is highly sensitive to the location of x, i.e. sensitive to noise. FIG. 4B shows the PLS model which requires one factor, i.e. one orthogonal projection to the one-dimensional subspace t₁ in X. In this case, the PLS projection Ŷ_{PLS} is not affected by the location of x, i.e. robust to noise. Although this example is idealized, it illustrates geometrically how PLS is more robust to noise and collinearity than OLS.

Industrial processes often experience time-varying changes, such as catalytic decaying, drifting, and degradation of efficiency. In these circumstances, a recursive algorithm is desirable to update the model based on new process data that reflect the process changes. A recursive PLS regression algorithm can update the model based on new data without increasing the size of data matrices. The PLS algorithm can be extended in the following aspects:
Provide a recursive PLS algorithm that gives identical results to the traditional PLS by updating the model with the number of factors equal to the rank of the X. This number is typically larger than that required by cross-validation for prediction, as is shown in Lemma 1 below.
Consider the case of rank deficient data X (Lemma 1) and provide a clear treatment for the output residual (Lemma 2).
   Assume that a pair of data matrices {X,Y} has m input variables, p output variables, n samples. To derive the recursive PLS algorithm, the following result is first presented.

Lemma 1. If rank(X)=r≦m, then

Eᵣ=Eᵣ₊₁= . . . =Eₘ=0. (13)

This lemma indicates that the maximum number of factors does not exceed r. The following notation is used to represent {T,W,P,B,Q} is the PLS results of data {X,Y} by the PLS algorithm,

$$\{ X , Y \} {}^{PLS} \{ T , W , P , B , Q \} \qquad ( 14 )$$

where
T=[t₁, t₂, . . . ,tᵣ]
W=[w₁, w₂, . . . ,wᵣ]
P=[p₁, p₂, . . . ,pᵣ]
B=diag{b₁, b₂, . . . ,bᵣ}
Q=[q₁, q₂, . . . ,qᵣ]
   B is the diagonal matrix for inner model coefficients. All possible number of factors equal to the rank of the input matrix, r are included. This is required by the result of Lemma 1.

(11) and (12) can be rearranged as

X=E₀=T P^{T}+Eᵣ=T P^{T} (15)

Y=TBQ^{T}+Fᵣ (16)

It should be noted that the residual matrix Fᵣ is generally not zero unless Y is exactly in the range space of X. However, it can be shown that Fᵣ is orthogonal to the scores, as summarized in the following lemma.

Lemma 2. The output residual Fᵢ is orthogonal to the scores of previous factors tₕ, i.e.

tₕ^{T}Fᵢ=0, for i≧h (17)

By minimizing the squared residuals, ∥Y−XC∥², we have

(X^{T}X)C=X^{T}Y. (18)

The PLS regression coefficient matrix is:

C^{PLS}=(X^{T}X)⁺X^{T}Y (19)

where (*)⁺ denotes the generalized inverse defined by the PLS algorithm. An explicit expression of the PLS regression coefficient matrix is

$$\begin{matrix}{C}^{PLS} = {W}^{*} {BQ}^{T} \\ where & ( 20 ) \\ {W}^{*} = [ {w}_{1}^{*} , {w}_{2}^{*} , … , {w}_{m}^{*} ] \\ and & ( 21 ) \\ {w}_{i}^{*} = {\prod }_{h + 1}^{i - 1} ( {I}_{m} - {w}_{h} {p}_{h}^{T} ) {w}_{i} . & ( 22 )\end{matrix}$$

When a new data pair {X₁,Y₁} is available and there is an interest in updating the PLS model using the augmented data matrices

$${X}_{new} = [ \begin{matrix}X \\ {X}_{1}\end{matrix} ] and {Y}_{new} [ \begin{matrix}Y \\ {Y}_{1}\end{matrix} ] ,$$

the resulting PLS model is

$${C}_{new}^{PLS} = ( {[ \begin{matrix}X \\ {X}_{1}\end{matrix} ]}^{T} [ \begin{matrix}X \\ {X}_{1}\end{matrix} ] ) + {[ \begin{matrix}X \\ {X}_{1}\end{matrix} ]}^{T} [ \begin{matrix}Y \\ {Y}_{1}\end{matrix} ] . \qquad ( 23 )$$

Since columns of T are mutually orthonormal, the following relation can be derived using (15) and (16) and Lemma 2,

X^{T}X=PT^{T}TP^{T}=PP^{T} (24)

X^{T}Y=PT^{T}TBQ^{T}+PT^{T}Fᵣ=PBQ^{T}. (25)

Therefore, (23) becomes,

$${C}_{new}^{PLS} = ( [ \begin{matrix}{P}^{T} \\ {X}_{1}\end{matrix} ] [ \begin{matrix}{P}^{T} \\ {X}_{1}\end{matrix} ] ) + {[ \begin{matrix}{P}^{T} \\ {X}_{1}\end{matrix} ]}^{r} [ \begin{matrix}{BQ}^{T} \\ {Y}_{1}\end{matrix} ] . \qquad ( 26 )$$

By comparing (26) with (23), we derive the following theorem.

Theorem 1. Given a PLS model,

$$\{ X , Y \} {\to }^{ PLS } \{ T , W , P , B , Q \}$$

and a new data pair {X₁,Y), performing PLS regression on data pair

$$[ \begin{matrix}{P}^{T} \\ {X}_{1}\end{matrix} ] , [ \begin{matrix}{BQ}^{T} \\ {Y}_{1}\end{matrix} ]$$

results in the same regression model as performing PLS regression on data pair

$$[ \begin{matrix}X \\ {X}_{1}\end{matrix} ] , [ \begin{matrix}Y \\ {Y}_{1}\end{matrix} ] .$$

It is easy to prove this theorem by comparing (26) with (23). Instead of using old data and new data to update the PLS model, the RPLS can update the model using the old model and new data. The RRPLS algorithm is summarized in Table 2.

It may be necessary in step 2 to check whether ∥Eᵣ∥≦ε, or the residual, is essential zero. Otherwise, (24) is not valid. Note that r can be different during the course of adaptation as more data are available (usually increasing).

TABLE 2
The recursive PLS (RPLS) algorithm

1. Formulate the data matrices {X, Y}. Scale the data to zero mean and
unit variance, or as otherwise specified with a set of weights.
2. Derive a PLS model using the algorithm in TABLE 1:
$\{ X , Y \} {\to }^{ PLS } \{ T , W , P , B , Q \} .$
Carry out the algorithm until ∥Eᵣ∥ ≦ ε(ε > 0 is the error tolerance). This
means that more factors are calculated than that required in
cross-validation to make theorem 1 hold.
3. When a new pair of data, {X₁, Y₁}, is available, scale it the same way
as it was done in step 1.
$Formulate X = [ \begin{matrix}{P}^{T} \\ {X}_{1}\end{matrix} ] , Y = [ \begin{matrix}{BQ}^{T} \\ {Y}_{1}\end{matrix} ] and return to step 2.$

If the number of rows of the data pair is defined as the PLS run-size, the RPLS updates the model with a PLS run-size of (r+n₁), while the regular PLS would update the model with a run-size of (n+n₁). One can easily see that the RPLS algorithm is much more efficient than the regular PLS if n>>r. Note that this is a typical case in process modeling and monitoring where tens of thousands of data samples are available for about a few dozens of process variables.

It should be noted that the recursive PLS algorithm includes the maximum possible number of PLS factors, r. However, to use the model for prediction, the number of factors is determined by cross-validation and is usually less than r. The purpose of carrying more factors than currently needed is not only to satisfy Theorem 1, but also to prepare for process changes in degrees of freedom or variability, which dictate the number of factors to vary. For example, when some variables were correlated in the past, but are not correlated given new data at present, an increase in the number of factors is required.

The above RPLS algorithm is derived with the assumption that the data X and Y are scaled to zero mean and unit variance. As new data are available, the mean and variance will change over time. Therefore, the scaling procedure in step 1 of the RPLS will not make the new data zero mean and unit variance. The role of unit variance scaling in PLS is to put equal weight on each input variable based on its variance, but the algorithm will still work if the data are not scaled to unit variance. This makes the RPLS algorithm work even though the variance may change over time.

However, if the mean of each variable in the data matrices is not zero, the input-output relationship has to be modified with the following general linear relationship,

$${y}_{i} = {Cx}_{i} + d = {[ \begin{matrix}C & d\end{matrix} ] [ \begin{matrix}{x}_{i}^{T} & 1\end{matrix} ]}^{T} \qquad ( 27 )$$

where xᵢ and yᵢ represent the ith rows of X and Y, respectively, and d ε [symbol] ^{p} is a vector of intercepts for the general linear model. Therefore, to model data with non-zero mean, the RPLS algorithm is simply applied on the following data pair,

$$\{ [ X \frac{1}{\sqrt{n - 1}} U ] , Y \} ,$$

where U ε [symbol] ⁿ is a vector whose elements are all one. The scaling factor

$$\frac{1}{\sqrt{n - 1}}$$

is to make the norm of

$$\frac{1}{\sqrt{n - 1}} 1$$

comparable to the norm of the columns of X, as the PLS algorithm is sensitive to how each input variable is scaled. The above treatment for non-zero mean data is consistent with that commonly used in linear regression. The only difference one can expect is that the PLS algorithm is biased linear regression, making the estimate of the intercept d also biased. However, the bias is introduced to reduce the variance and minimize the overall mean squared error. In the limit of r factors being used in the PLS model, the PLS regression approaches OLS regression. Another way to interpret the treatment is that PLS is equivalent to a conjugate gradient approach to linear regression. The effect of this treatment will be demonstrated with an application later in this paper.

Theorem 1 gives a RPLS algorithm which updates the model as soon as some new samples are available. It may be desirable not to update the model until significant amount of data are collected and the process has gone through significant changes. In this case a new block of data can be accumulated, a PLS sub-model on the new data block can be derived, and then it can be combined with the existing model. Assuming the PLS sub-model on the new data block is,

$$\{ {X}_{1} , {Y}_{1} \} {\to }^{ PLS } \{ {T}_{1} , {W}_{1} , {P}_{1} , {B}_{1} , {Q}_{1} \} \qquad ( 28 )$$

The PLS regression can be calculated from (23) as follows,

$$\begin{matrix}{C}_{new}^{PLS} = {( {X}_{new}^{T} {X}_{new} )}^{+} {X}_{new}^{T} {Y}_{new} \\ = {( {PP}^{T} + {P}_{1} {P}_{1}^{T} )}^{+} ( {PBQ}^{T} + {P}_{1} {B}_{1} {Q}_{1}^{T} ) \\ = {{( {[ \begin{matrix}{P}^{T} \\ {P}_{1}^{T}\end{matrix} ]}^{T} [ \begin{matrix}{P}^{T} \\ {P}_{1}^{T}\end{matrix} ] )}^{+} [ \begin{matrix}{P}^{T} \\ {P}_{1}^{T}\end{matrix} ]}^{T} [ \begin{matrix}{BQ}^{T} \\ {B}_{1} {Q}_{1}^{T}\end{matrix} ]\end{matrix} \qquad ( 29 )$$

Therefore, a PLS model based on two data blocks is equivalent to combining the two sub-models.

Theorem 2. Assuming two PLS models as given in (14) and (28), performing PLS regression on

$$[ \begin{matrix}{P}^{T} \\ {P}_{1}^{T}\end{matrix} ] , [ \begin{matrix}{BQ}^{T} \\ {B}_{1} {Q}_{1}^{T}\end{matrix} ]$$

results in the same regression model as performing PLS regression on the data pair

$$[ \begin{matrix}X \\ {X}_{1}\end{matrix} ] , [ \begin{matrix}Y \\ {Y}_{1}\end{matrix} ] .$$

As an extension, if there are s blocks of data, and

$$\{ {X}_{i} , {Y}_{i} \} {\to }^{ PLS } \{ {T}_{i} , {W}_{i} , {P}_{i} , {B}_{i} , {Q}_{i} \} ; \\ i = 1 , 2 , … , s \qquad ( 30 )$$

performing PLS regression on all data is equivalent to performing PLS regression on the following pair of matrices

$$[ \begin{matrix}{P}_{1}^{T} \\ {P}_{2}^{T} \\ ⋮ \\ {P}_{1}^{T}\end{matrix} ] , [ \begin{matrix}{B}_{1} {Q}_{1}^{T} \\ {B}_{2} {Q}_{2}^{T} \\ ⋮ \\ {B}_{1} {Q}_{1}^{T}\end{matrix} ]$$

Theorem 2 can be proven by comparing (23) and (29) for two blocks of data, and similar results can be obtained with s blocks. The block-wise RPLS algorithm can be summarized in Table 3.

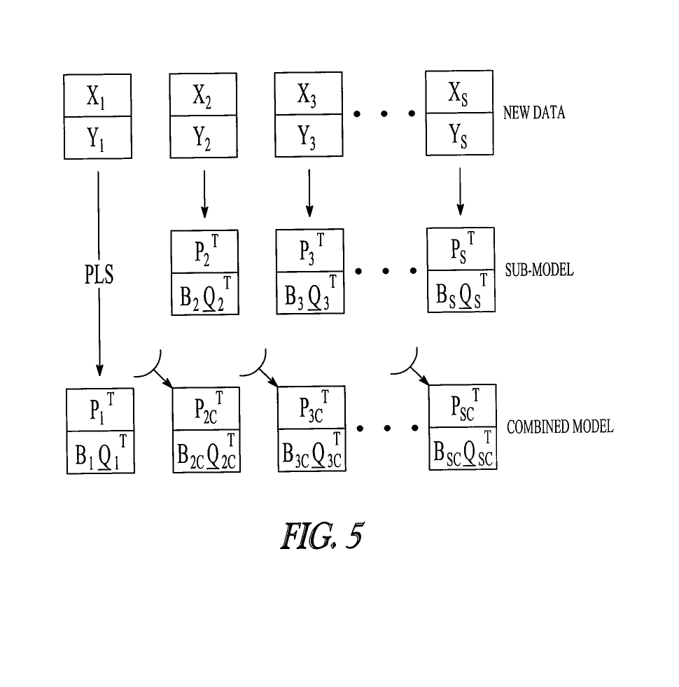

The procedure of this block-wise RPLS algorithm is illustrated in FIG. 5. Updating the PLS model involves performing PLS on the existing model and the new sub-model, which requires much less computation than updating the PLS using the entire data set. The block-wise RPLS algorithm computes a sub-model with a run-size of n₁ and a updated model with a run-size of (2r). The block RPLS algorithm has its computational advantage for on-line adaptation with a moving window and in cross-validation for off-line PLS modeling, which will be demonstrated in the following sections.

To adequately adapt process changes, it is desirable to exclude extremely old data because the process has changed. A moving window approach can be used to incorporate new data and drop out old data. The objective function for the PLS algorithm with a moving window can be written as

TABLE 3
The block-wise RPLS algorithm

1. Formulate the data matrices {X, Y}. Scale the data to zero mean and
unit variance, or as otherwise specified.
2. Derive a PLS model using the algorithm in TABLE 1:
$\{ X , Y \} {\to }^{ PLS } \{ T , W , P , B , Q \} .$
Carry out the algorithm until Eᵣ = 0.
3. When a new pair of data, {X₁, Y₁,}, is available, scale it the same way
as it was done in step 1. Perform PLS to derive a sub-model:
$: \{ {X}_{1} , {Y}_{1} \} {\to }^{ PLS } \{ {T}_{1} , {W}_{1} , {P}_{1} , {B}_{1} , {Q}_{1} \} .$
$4. Formulate X = [ \begin{matrix}{P}^{T} \\ {P}_{1}^{T}\end{matrix} ] , Y = [ \begin{matrix}{BQ}^{T} \\ {B}_{1} {Q}_{1}^{T}\end{matrix} ] and return to step 2.$

$$\begin{matrix}{J}_{s , w} = {‖ [ \begin{matrix}{Y}_{s} & & {X}_{s} \\ {Y}_{s - 1} & - & {X}_{s - 1} \\ ⋮ & & ⋮ \\ {Y}_{s - w + 1} & & {X}_{s - w + 1}\end{matrix} ] C ‖}^{2} \\ = {\sum }_{i = s - w + 1}^{s} {‖ {Y}_{i} - {X}_{i} C ‖}^{2} \\ = {\sum }_{i = s - w + 1}^{s} {‖ {T}_{i} ( {B}_{i} {Q}_{i}^{T} - {P}_{i}^{T} C ) + {F}_{n} ‖}^{2} \\ = {\sum }_{i = s - w + 1}^{s} trace \{ [ {T}_{i} ( {B}_{i} {Q}_{i}^{T} - {P}_{i}^{T} C ) + \\ { {F}_{ri} ]}^{T} [ {T}_{i} ( {B}_{i} {Q}_{i}^{T} - {P}_{i}^{T} C ) + {F}_{ri} ] \}\end{matrix} \qquad ( 31 )$$

where w is the number of blocks in the window and s represents the current block of data. By using Lemma 2,

Tᵢ^{T}Fᵣᵢ=0 (32)

and Tᵢ^{T}Tᵢ=I, the following is obtained,

$$\begin{matrix}{J}_{s , w} = {\sum }_{i = s - w + 1}^{s} trace \{ {[ {B}_{i} {Q}_{i}^{T} - {P}_{i}^{T} C ]}^{T} [ {B}_{i} {Q}_{i} - {P}_{i}^{T} C ] \} + \\ t race \{ {F}_{ri}^{t} {F}_{ri} \} \\ = {\sum }_{i = s - w + 1}^{s} {‖ {B}_{i} {Q}_{i} - {P}_{i}^{T} C ‖}^{2} + {‖ {F}_{ri} ‖}^{2} \\ = ‖ [ \begin{matrix}{B}_{s} {Q}_{s}^{T} \\ {B}_{s - 1} {Q}_{s - 1}^{T} \\ ⋮ \\ {B}_{s - w + 1} {Q}_{s - w + 1}^{T}\end{matrix} ] - [ \begin{matrix}{P}_{s}^{T} \\ {P}_{s - 1}^{T} \\ ⋮ \\ {P}_{s - w + 1}^{T}\end{matrix} ] C {‖}^{2} + {\sum }_{i = s - w + 1}^{s} ‖ {F}_{ri} {‖}^{2}\end{matrix} \qquad ( 33 )$$

Since the second term on the right hand side of the above equation is a constant, it can be dropped out of the objective function. Therefore, minimizing the objective function in (31) is equivalent to minimizing that in (33), except that the number of rows in (33) can be much fewer than that in (31). We can simply perform PLS regression on the following pair of matrices

$$[ \begin{matrix}{P}_{s}^{T} \\ {P}_{s + 1}^{T} \\ ⋮ \\ {P}_{s - w + 1}^{T}\end{matrix} ] , [ \begin{matrix}{B}_{s} {Q}_{s}^{T} \\ {B}_{s + 1} {Q}_{s + 1}^{T} \\ ⋮ \\ {B}_{s - w + 1} {Q}_{s - w + 1}\end{matrix} ]$$

as the input and output matrices, respectively. When a new block of data (s+1) is available, a PLS sub-model is first derived to obtain Pₛ₊₁^{T}, and Bₛ₊₁Qₛ₊₁^{T}. Then they are augmented into the top row of the above matrices and the bottom row is dropped out. The window size w, which is the number of blocks, controls how old the data that are kept in the window. The smaller the window size, the faster the model adapts new data and forgets old data. Assuming each data block has n₁ samples, the block-wise RPLS update the model with a run-size of (rw), while the regular PLS would update the model for a run-size of n₁w. Clearly, the RPLS algorithm with a moving window is advantageous when n₁>r.

An alternative approach to on-line adaptation is to use forgetting factors. The use of forgetting factors is well known in recursive least squares. A forgetting factor is incorporated in the block-wise RPLS algorithm to adapt process changes. To derive the recursive regression, we start the PLS modeling on the first data block by minimizing (from (33) after ignoring the constant term):

J₁=∥B₁Q₁^{T}−P₁^{T}C∥² (34)

With s blocks of data available, we minimize the following objective function with a forgetting factor,

$$\begin{matrix}{J}_{s , λ} = {‖ [ \begin{matrix}1 & & & \\ & λ & & \\ & & ⋯ & \\ & & & {λ}^{s - 1}\end{matrix} ] ( [ \begin{matrix}{B}_{s} {Q}_{s}^{T} \\ {B}_{s - 1} {Q}_{s - 1}^{T} \\ ⋮ \\ {B}_{1} {Q}_{1}^{T}\end{matrix} ] - [ \begin{matrix}{P}_{s}^{T} \\ {P}_{s - 1}^{T} \\ ⋮ \\ {P}_{1}^{T}\end{matrix} ] ) C \text{)} ‖}^{2} \\ = {λ}^{2} {‖ [ \begin{matrix}1 & & & \\ & λ & & \\ & & ⋯ & \\ & & & {λ}^{s - 2}\end{matrix} ] ( [ \begin{matrix}{B}_{s - 1} {Q}_{s - 1}^{T} \\ {B}_{s - 2} {Q}_{s - 2}^{T} \\ ⋮ \\ {B}_{1} {Q}_{1}^{T}\end{matrix} ] - [ \begin{matrix}{P}_{s - 1}^{T} \\ {P}_{s - 2}^{T} \\ ⋮ \\ {P}_{1}^{T}\end{matrix} ] ) C \text{)} ‖}^{2} + \\ {‖ {B}_{s} {Q}_{s}^{T} - {P}_{s}^{T} C ‖}^{2} \\ = {λ}^{2} {J}_{s - 1 , λ} + {‖ {B}_{s} {Q}_{s}^{T} - {P}_{s}^{T} C ‖}^{2}\end{matrix} \qquad ( 35 )$$

where 0<λ≦1 is the forgetting factor. J_{s-1,λ} is the objective function at step s−1. This expression indicates that the weights on old data blocks decay exponentially. A smaller λ will forget old data faster. Assuming at step s−1 we have a combined model {P_{sc}^{T},B_{sc}Q_{sc}^{T}}, according to Theorem 2, (35) can be rewritten as

$$\begin{matrix}{J}_{s , λ} = {λ}^{2} {‖ {B}_{sc} {Q}_{sc}^{T} - {P}_{sc}^{T} C ‖}^{2} + {‖ {B}_{s} {Q}_{s}^{T} - {P}_{s}^{T} C ‖}^{2} \\ = {‖ [ \begin{matrix}{B}_{1} {Q}_{s}^{T} \\ λ {B}_{sc} {Q}_{sc}^{T}\end{matrix} ] - [ \begin{matrix}{P}_{s}^{T} \\ λ {P}_{sc}^{T}\end{matrix} ] C ‖}^{2}\end{matrix} \qquad ( 36 )$$

Therefore, the PLS model at step s can be obtained by performing PLS using

$$[ \begin{matrix}{P}_{s}^{T} \\ λ {P}_{sc}^{T}\end{matrix} ]$$

as the input matrix and

$$[ \begin{matrix}{B}_{S} {Q}_{s}^{T} \\ λ {B}_{sc} {Q}_{sc}^{T}\end{matrix} ]$$

as the output matrix. To update a RPLS model with a forgetting factor, one simply needs to derive a sub-model on the current data block, then combine it with the old model with a forgetting factor. The computation effort in updating the model is equivalent to performing a PLS regression with a run-size 2r.

The forgetting factor approach is computationally more efficient than the moving window approach. Table 4 compares the computation load in terms of PLS run-sizes for the batch PLS, recursive PLS, block RPLS, block RPLS with moving windows, and block RPLS with forgetting factors. Typically, n₁>r and s>w. Therefore, the computation load is significantly reduced in the RPLS and the block RPLS with forgetting factors.

In process applications, the number of data samples available for modeling is often very large. In this case, the data can be divided into s blocks and leave-one block-out cross-validation can be performed. After the number of factors is determined through cross-validation, a final PLS model is obtained by performing PLS regression on all available data. Since the regular cross-validation involves modeling the data repeatedly, it is computationally inefficient. In this section, we use the block RPLS to reduce the computation load in cross-validation and final PLS modeling.

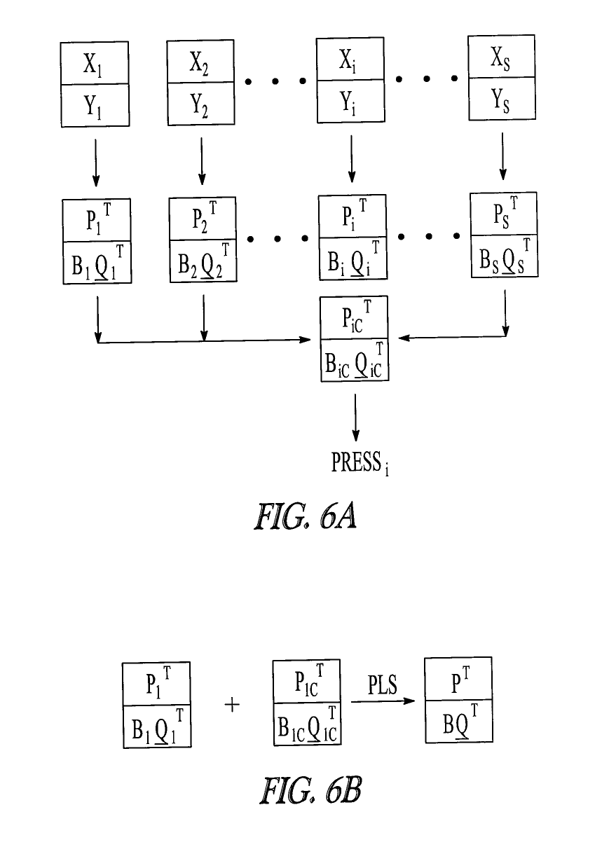

FIGS. 6A and 6B illustrate the use of block RPLS for cross-validation and final PLS modeling to improve the computation efficiency. First, the data are divided into s blocks, as in the regular cross-validation. Then a sub-model is built for each block using PLS regression. Third, the PRESS error is calculated by the leave-one-block-out approach. Assuming the ith block out is left and a PLS model is built on the remaining blocks, the following objective function is minimized (similar to (33)),

TABLE 4
The PLS run-sizes for the batch PLS, recursive PLS, block RPLS,
block RPLS with moving windows, and block RPLS with
forgetting factors.*

| | | | | | Block RPLS |
|---|---|---|---|---|---|
| | | | | Block RPLS | with |
| | | Recursive | Block | with moving | forgetting |
| | Batch PLS | PLS | RPLS | windows | factors |
| Sub-model | None | None | n₁ | n₁ | n₁ |
| Update | S * n₁ | r + n₁ | s * r | w * r | 2 * r |

n₁: number of samples in a block;
r: rank of the input data matrix;
s: number of blocks;
w: window size in blocks.

$${J}_{ic} = {\sum }_{j = 1 j \neq 1}^{s} {‖ {B}_{j} {Q}_{j}^{T} - {P}_{j}^{T} C ‖}^{2} \qquad ( 37 )$$

which means that a PLS model is built by combining all sub-models except the ith one,

$${C}_{ic}^{PLS} = {( {\sum }_{j = 1 j \neq 1}^{s} {P}_{j} {P}_{j}^{T} )}^{+} ( {\sum }_{j = 1 j \neq 1}^{s} {P}_{j} {B}_{j} {Q}_{j}^{T} ) \qquad ( 38 )$$

where C_{ic}^{PLS} denotes a PLS model derived from all data but the ith block. By leaving out each block in turn, the cross-validated PRESS corresponding to the number of factors is

$$PRESS ( h ) = {\sum }_{i = 1}^{s} {PRESS}_{i} = {\sum }_{i = 1}^{s} {‖ {Y}_{i} - {X}_{i} {C}_{ic}^{PLS} ‖}^{2} \qquad ( 39 )$$

The number of factors that gives minimum PRESS is used in the final PLS modeling.

The final PLS model can be obtained by simply performing PLS regression on an intermediate model derived in the process of cross-validation. For example, assuming leaving out {X₁,Y₁} results in a PLS model {P_{ic}^{T}B_{ic}Q_{ic}^{T}}, the final PLS model can be derived by performing PLS regression on

$$[ \begin{matrix}{P}_{1 c}^{T} \\ {P}_{1}^{T}\end{matrix} ] , [ \begin{matrix}{B}_{1 c} {Q}_{1 c}^{T} \\ {B}_{1} {Q}_{1}^{T}\end{matrix} ]$$

In both cross-validation and final PLS modeling, the amount of computation is significantly reduced for modeling a large number of data samples.

One type of dynamic model is the auto-regressive model with exogenous inputs

$$y ( k ) = {\sum }_{i = 1}^{{n}_{y}} {A}_{i} y ( k - i ) + {\sum }_{j = 1}^{{n}_{u}} {B}_{j} u ( k - j ) + v ( k ) \qquad ( 40 )$$

where y(k), u(k) and v(k) are the process output, input, and noise vectors, respectively, with appropriate dimensions for multi-input-multi-output systems. Aᵢ and Bⱼ are matrices of model coefficients to be identified. n_{y} and nᵤ are time lags for the output and input, respectively. In order for the PLS method to build an ARX model, the following vector of variables is defined,

x^{T}(k)=[y^{T}(k−1),y^{T}(k−2), . . . ,y^{T}(k−n_{y}),u^{T}(k−1),u^{T}(k−2), . . . ,u^{T}(k−nᵤ)] (41)

whose dimension is denoted as m. Then two data matrices can be formulated as follows assuming the number of data records is n,

X=[x(1),x(2), . . . ,x(n)]^{T} ε [symbol] ^{n×m} (42)

Y=[y(1),y(2), . . . ,y(n)]^{T} ε [symbol] ^{n×p} (43)

where p is the dimension of output vector y(k). Defining all unknown parameters in the ARX model as,

C=└A₁,A₂, . . . ,Aₙ_{_{y}},B₁,B₂, . . . ,Bₙ_{ᵤ}┘^{T} ε [symbol] ^{m×p} (44)

Eq. (40) can be re-written as

y(k)=C^{T} x(k)+v(k) (45)

and the two data matrices Y and X can be related as

Y=XC+V (46)

The RPLS algorithms disclosed herein can be readily applied.

It should be noted that the ARX model derived from PLS algorithms is inherently an equation error approach (or series-parallel scheme) in system identification that the ARX model with series-parallel identification scheme tends to emphasize auto-regression terms with poor long-term prediction accuracy. However, a finite impulse response (FIR) model is often preferred and is applicable for stable processes, which can be described as

$$y ( k ) = {\sum }_{j = 1}^{N} {B}_{j} u ( k - j ) + v ( k ) \qquad ( 47 )$$

where N is the truncation number that corresponds to the process settling time. Similar to the ARX model, two data matrices X and Y can be arranged accordingly. It is straight forward to apply the RPLS algorithms to this class of models.

Traditional PLS algorithms have been extended to nonlinear modeling and data analysis. There are generally two approaches to extending the traditional PLS to include nonlinearity. One approach is to use nonlinear inner models, such as polynomials. Another approach is to augment the input matrix with nonlinear functions of the input variables. For example, one may use quadratic combinations of the inputs as additional input to the model to build nonlinearity.

Since the RPLS algorithms proposed in this paper make use of the linear property of the PLS inner models, it is difficult to develop a nonlinear RPLS algorithm with nonlinear inner relations. However, one can always augment the input with nonlinear functions of the inputs to introduce nonlinearity in the model. For example, it is straight forward to include quadratic terms in the input matrix, as it is done in the traditional PLS regression. If both quadratic inputs and a dynamic FIR formulation is used, the model format for a single-input-single-output process can be represented as,

$$y ( k ) = {y}_{0} + {\sum }_{j = 1}^{N} {a}_{j} u ( k - j ) + {\sum }_{i = 1}^{N} {\sum }_{j = 1}^{N} {b}_{ij} u ( k - i ) u ( k - j ) + v ( k ) \qquad ( 48 )$$

where the bias term y₀ is required even though the input and output are scaled to zero mean. The resulting model is actually a second order Volterra series model. In this configuration, it is necessary to discard terms that have little contribution to the output variables. This issue of discarding unimportant input terms deserves further study.

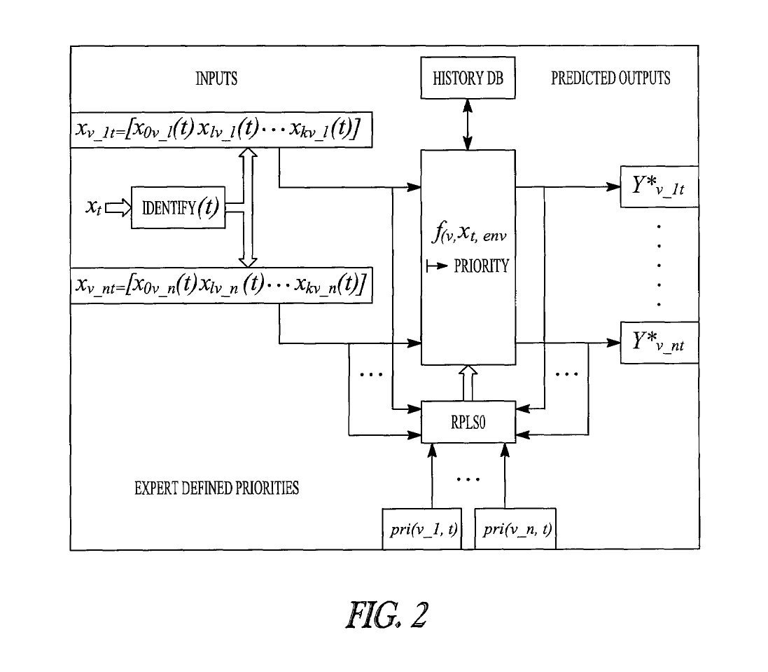

Partial Least Square (PLS) based regression is an extension of the basic least square regression technique which can effectively analyze data with many noisy, co-linear, and even incomplete variables as input or output. An RPLS algorithm as described above in Table 2 and as illustrated in FIG. 2 is applied. The input-output matrices for the RPLS algorithm are first determined.

For a violation type v, define

Yᵥₜ=pri(v, t)=Δₜ(v)

As a history adapted response of the system administrator for a violation instance of v in χₜ. Let

Yᵥ=[Yᵥ₀, Yᵥ₁, . . . ]^{T}

be a column vector collecting Yᵥₜ for all the instances of the violation type v present in χ₀ χ₁, . . . . Also define

Xᵥₜ=[x₀ᵥ(t) x₁ᵥ(t) . . . xₖᵥ(t)]

where xᵢᵥ(t) is the value of the i^{th} factor xᵢᵥ at time t,

And further define

Xᵥ=[xᵥ₀ Xᵥ₁ . . . Xᵥₜ]

Note that,

Yᵥ=XᵥBᵥ, where Bᵥ=[Δ₀ᵥβ₁ᵥ . . . βₖᵥ]

Now, the basic RPLS algorithm as described above can be used to get the regression estimates for Bᵥ.

The algorithm is as follows:
Identify( ): Identify the set of violations where meta factors might be potentially present.
Step#i1: Initialize a Boolean type array Direction [ ] for each violation w in χₜ: for all the violations (w in χₜ)
Direction[w]=0;
Step#i2: Identify the directionality mismatch between the system response and the expert response.

```
for all violation pairs (v, w) in (χₜ×χₜ) { × denotes the
Cartesian product of the sets
  if (Direction[v] = = 0) OR (Direction[w] = = 0) {
      if (φₜ(v, w) = = 0) {
          Direction[v] = 1
          Direction[w] = 1
      }
  }
}
```

Step#i3: Collect those violations in χₜ for which is there is no directionality mismatch:

```
  For all violations w in χₜ {
    if (Direction[w] = = 1)
      Remove w from χₜ
  }
}
```

RPLS( ): Apply the RPLS described in Table 2 as follows.
For all the violations (types) v in χₜ {
   Step#r1: Scale the data matrices {Xᵥ; Yᵥ} to zero mean and unit variance.
   Step#r2: Derive a PLS model using the basic RPLS algorithm presented above. {Xᵥ; Yᵥ}→{T;W;P;B;Q}. Carryout the algorithm until ∥Eᵣ∥≦ε, where r=rank(Xᵥ) and ε is the error tolerance.
   Step#r3: When a new pair of data (or a batch of data) {Xᵥₜ₊₁; Yᵥₜ₊₁} is available, scale it the same way as step#r1. Let Xᵥ=[P^{T} Xᵥₜ₊₁]^{T} and Yᵥ=[BQ^{T} Yᵥₜ₊₁]^{T} and return to step#r2.

The adaptive learning framework discussed above can be operationalized by implementing the disclosed learning system. At the beginning, the system would need to be initialized by the system experts for the set of relevant violations deemed significant for the organization, together with the set of environmental factors. The coefficients βᵢᵥ in equation (0) can be initialized to 1 in the beginning (or as specified by the system expert).

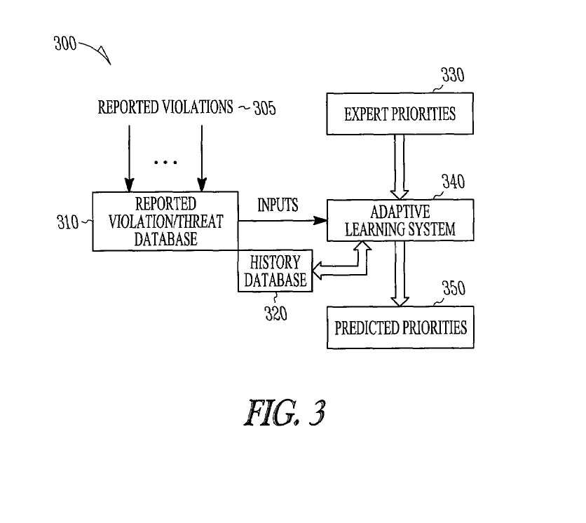

FIG. 3 illustrates an example embodiment of a high level schematic representation of an overall system design 300. The learning system can be integrated with a database 310 containing a list of reported threats and/or violations 305 for the associated factors. A suitable interface could be used to get inputs from the security experts 330, determine the expert assigned priorities to these reported policy threats and/or violations, and determine the criticality level of these threats and/or violations. Based upon these inputs and the valuations of the associated factors, the system could calculate the relative priority of a reported policy threat and/or violation. In turn, the system could adapt the weights (340) of the factors for those threats and/or violations in which its calculated priorities (350) had significant deviation from the expert assigned priorities.

The system can be executed in various modes. For example, the system can be executed in an online mode or an offline mode. This may depend upon the choice of the time intervals (updation periods) at which the implemented system is presented with the new data (reported violations/threats) as decided by the system experts at the time of the execution. If the choice of the time interval is comparable (or less than) the rate at which new threats and/or violations are being reported, the system could effectively work in an online mode, and depict the priorities as each new threat and/or violation is reported, and adapt itself as per the expert response corresponding to the threat and/or violation. On the other hand, if a time interval of new data with which the system is presented is relatively large, then the system could effectively operate in an offline mode using the batch of data together. A choice of the updating period could determine when the learning system fetches the new set of data from the database of reported violations.

The model can be practiced in both real-time as well as in non-real-time modes. This can depend upon the clock synchronization for the time intervals (updating periods) at which the implemented system is presented with the new data (reported threats and/or violations) and the time at which it was actually reported. Thus, for real-time execution learning, the system could be tightly coupled with the database of reported violations so that as and when a new threat and/or violation is being reported, the learning system can work with it. Also, for that purpose, the database updating should be updated on real-time basis. For non-real-time mode of operation, the learning system could be presented the new data as per the settings defined by the system expert. The model can be practiced in both centralized as well as in decentralized modes. The differentiation arises in the modes of maintaining the reported threat and/or violation database. In a case in which decentralized databases are being maintained at different sites, different copies of the learning process can execute at these decentralized sites while simultaneously integrating with local databases. Multiple processes could adapt for the same type of the violations at different sites. In order for these processes to synchronize with each other for the learning rules for those types of threats and/or violations that are exclusively being handled at only one site, the corresponding process should send the latest model (Eq (0)) to the another processes together with the History database 320 (See FIG. 3). After receiving the model as well the history database, another process could start adapting the model. For those types of threats and/or violations for which different processes at different sites have evolved different models, a possible way when two processes synchronize is to keep that model which possibly has evolved using larger number of reported violations until that moment. Such decisions should be made by the system experts on a case by case basis. Another alternative is to send the copy of the violation database to another process at another site, and the violation database can then be used by the process at the other site to adapt its own model further and then communicate the updated model back to the original process for future application.

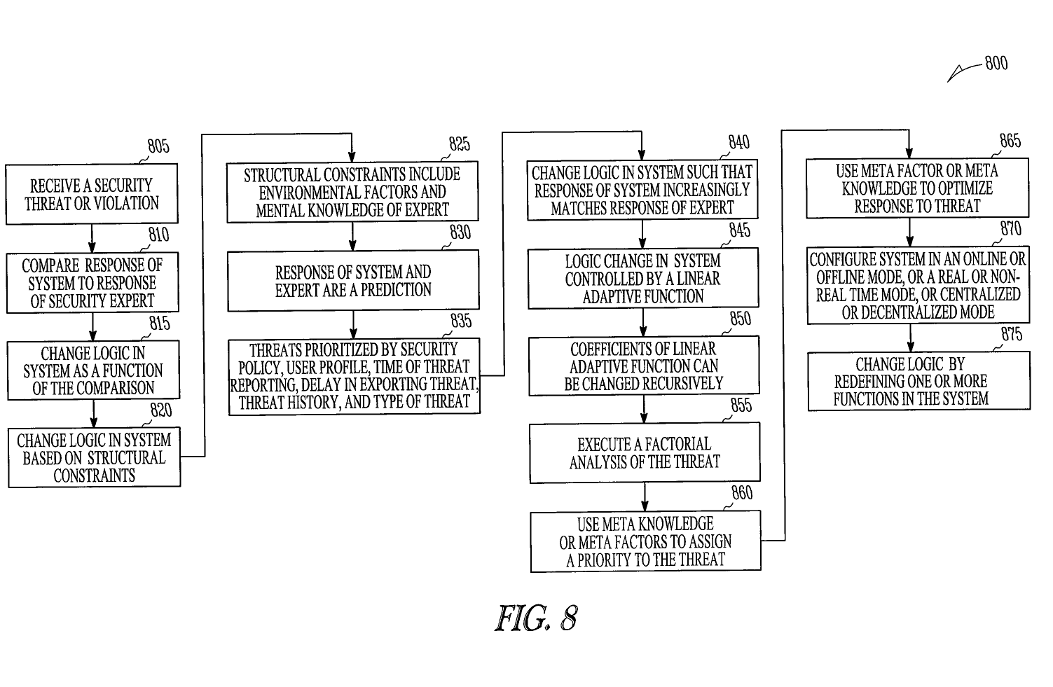

FIG. 8 is a flowchart of an example process 800 for prioritizing threats or violations in a security system. FIG. 8 includes a number of process blocks 805-875. Though arranged serially in the example of FIG. 8, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring specifically to FIG. 8, at 805, a security system is configured to prioritize threats or violations by receiving a reported security threat or violation. At 810, the system compares a response of the system to the reported security threat or violation to a response of a security expert to the reported security threat or violation, and at 815, the system changes logic in the system as a function of the comparison. At 820, the changing logic in the system is controlled by one or more structural constraints, and at 825, the structural constraints comprise environmental factors and meta knowledge of an expert. At 830, the response of the system and the response of the security expert are a prediction. At 835, the system is configured to prioritize threats or violations by considering one or more of an associated security policy, a profile of a user reporting a threat or violation, a time at which the threat or violation is reported, a delay in reporting the threat or violation, a past threat or violation history, and a type of the threat or violation. At 840, the changing of the logic in the system comprises a change such that the response of the system increasingly matches the response of the security expert over a time period. At 845, the changing logic in the system is controlled by a linear adaptive function. At 850, the linear adaptive function includes coefficients that can be changed recursively. At 855, the system is configured to execute a factorial analysis of the threat or violation in terms of measurable factors of an organization associated with the threat or violation. At 860, the system is configured to use meta knowledge or meta factors for assigning a relative priority to the threat or violation. At 865, the system is configured to identify a presence of a meta factor or meta knowledge used by a security expert for optimizing a response to the threat or violation. At 870, the system is configured in one or more of an online mode and an offline mode, the system is configured in one or more of a real-time mode and a non-real-time mode, and/or the system is configured in one or more of a centralized mode and a decentralized mode. At 875, the changing of the logic in the system comprises redefining one or more functions in the system.

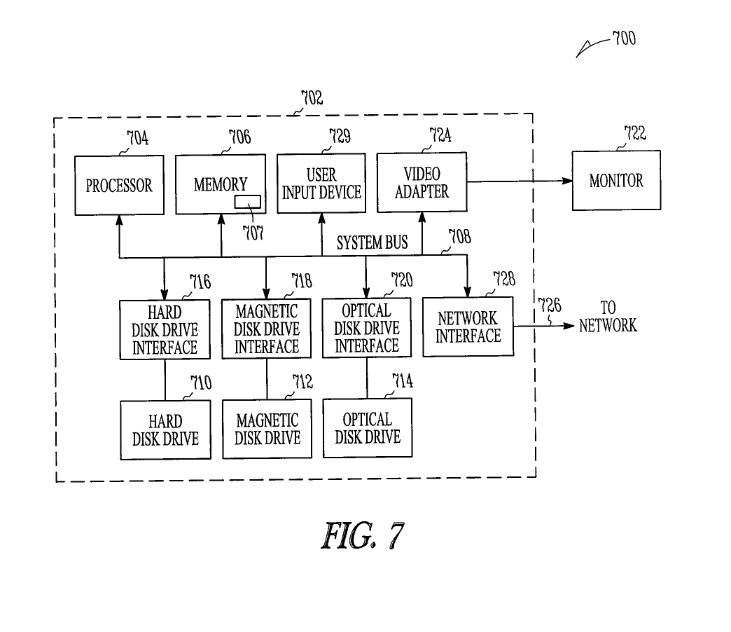

FIG. 7 illustrates a block diagram of a data-processing apparatus 700, which can be adapted for use in implementing a preferred embodiment. It can be appreciated that data-processing apparatus 700 represents merely one example of a device or system that can be utilized to implement the methods and systems described herein. Other types of data-processing systems can also be utilized to implement the present invention. Data-processing apparatus 700 can be configured to include a general purpose computing device 702. The computing device 702 generally includes a processing unit 704, a memory 706, and a system bus 708 that operatively couples the various system components to the processing unit 704. One or more processing units 704 operate as either a single central processing unit (CPU) or a parallel processing environment. A user input device 729 such as a mouse and/or keyboard can also be connected to system bus 708.

The data-processing apparatus 700 further includes one or more data storage devices for storing and reading program and other data. Examples of such data storage devices include a hard disk drive 710 for reading from and writing to a hard disk (not shown), a magnetic disk drive 712 for reading from or writing to a removable magnetic disk (not shown), and an optical disk drive 714 for reading from or writing to a removable optical disc (not shown), such as a CD-ROM or other optical medium. A monitor 722 is connected to the system bus 708 through an adaptor 724 or other interface. Additionally, the data-processing apparatus 700 can include other peripheral output devices (not shown), such as speakers and printers.

The hard disk drive 710, magnetic disk drive 712, and optical disk drive 714 are connected to the system bus 708 by a hard disk drive interface 716, a magnetic disk drive interface 718, and an optical disc drive interface 720, respectively. These drives and their associated computer-readable media provide nonvolatile storage of computer-readable instructions, data structures, program modules, and other data for use by the data-processing apparatus 700. Note that such computer-readable instructions, data structures, program modules, and other data can be implemented as a module 707. Module 707 can be utilized to implement the methods depicted and described herein. Module 707 and data-processing apparatus 700 can therefore be utilized in combination with one another to perform a variety of instructional steps, operations and methods, such as the methods described in greater detail herein.

Note that the embodiments disclosed herein can be implemented in the context of a host operating system and one or more module(s) 707. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 700, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMS), and read only memories (ROMs) can be used in connection with the embodiments.

A number of program modules, such as, for example, module 707, can be stored or encoded in a machine readable medium such as the hard disk drive 710, the, magnetic disk drive 712, the optical disc drive 714, ROM, RAM, etc. or an electrical signal such as an electronic data stream received through a communications channel. These program modules can include an operating system, one or more application programs, other program modules, and program data.

The data-processing apparatus 700 can operate in a networked environment using logical connections to one or more remote computers (not shown). These logical connections can be implemented using a communication device coupled to or integral with the data-processing apparatus 700. The data sequence to be analyzed can reside on a remote computer in the networked environment. The remote computer can be another computer, a server, a router, a network PC, a client, or a peer device or other common network node. FIG. 7 depicts the logical connection as a network connection 726 interfacing with the data-processing apparatus 700 through a network interface 728. Such networking environments are commonplace in office networks, enterprise-wide computer networks, intranets, and the Internet, which are all types of networks. It will be appreciated by those skilled in the art that the network connections shown are provided by way of example and that other means and communications devices for establishing a communications link between the computers can be used.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A security system configured to:
prioritize threats or violations by:
receiving a reported security threat or violation;
comparing a response of the system to the reported security threat or violation to a response of a security expert to the reported security threat or violation; and
changing logic in the system as a function of the comparison.

2. The system of claim 1, wherein the changing logic in the system is controlled by one or more structural constraints.

3. The system of claim 2, wherein the structural constraints comprise environmental factors and meta knowledge of an expert.

4. The system of claim 1, wherein the response of the system and the response of the security expert are a prediction.

5. The system of claim 1, wherein the system is configured to prioritize threats or violations by considering one or more of an associated security policy, a profile of a user reporting a threat or violation, a time at which the threat or violation is reported, a delay in reporting the threat or violation, a past threat or violation history, and a type of the threat or violation.

6. The system of claim 1, wherein changing logic in the system comprises a change such that the response of the system increasingly matches the response of the security expert over a time period.

7. The system of claim 1, wherein changing logic in the system is controlled by a linear adaptive function.

8. The system of claim 7, wherein the linear adaptive function includes coefficients that can be changed recursively.

9. The system of claim 1, wherein the system is configured to execute a factorial analysis of the threat or violation in terms of measurable factors of an organization associated with the threat or violation.

10. The system of claim 1, wherein the system is configured to use meta knowledge or meta factors for assigning a relative priority to the threat or violation.

11. The system of claim 1, wherein the system is configured to identify a presence of a meta factor or meta knowledge used by a security expert for optimizing a response to the threat or violation.

12. The system of claim 1, wherein the system is configured in one or more of an online mode and an offline mode.

13. The system of claim 1, wherein the system is configured in one or more of a real-time mode and a non-real-time mode.

14. The system of claim 1, wherein the system is configured in one or more of a centralized mode and a decentralized mode.

15. The system of claim 1, wherein the changing logic in the system comprises redefining one or more functions in the system.

16. A process to prioritize threats or violations in a security system comprising:
receiving a reported security threat or violation;
comparing a response of the system to the reported security threat or violation to a response of a security expert to the reported security threat or violation; and
changing logic in the system as a function of the comparison.

17. The process of claim 16, wherein the system is configured to prioritize threats or violations by considering one or more of an associated security policy, a profile of a user reporting a threat or violation, a time at which the threat or violation is reported, a delay in reporting the threat or violation, a past threat or violation history, and a type of the threat or violation.

18. The process of claim 16, wherein changing logic in the system comprises a change such that the response of the system increasingly matches the response of the security expert over a time period.

19. A computer readable medium including instructions that when executed by a processor executes a process comprising:
receiving a reported security threat or violation;
comparing a response of the system to the reported security threat or violation to a response of a security expert to the reported security threat or violation; and
changing logic in the system as a function of the comparison.

20. The computer readable medium of claim 19,
wherein the computer readable medium is configured to prioritize threats or violations by considering one or more of an associated security policy, a profile of a user reporting a threat or violation, a time at which the threat or violation is reported, a delay in reporting the threat or violation, a past threat or violation history, and a type of the threat or violation; and
wherein changing logic in the system comprises a change such that the response of the system increasingly matches the response of the security expert over a time period.
